(19) United States
(12) Patent Application Publication
(10) Pub. No.: US 2019/0023114 A1
(43) Pub. Date: Jan. 24, 2019

(54) AUXILIARY POWER SYSTEM AND METHODS FOR HYBRID VEHICLES

(71) Applicant: Patrick Nguyen Huu, Irvine, CA (US)

(72) Inventor: Patrick Nguyen Huu, Irvine, CA (US)

(21) Appl. No.: 15/825,011

(22) Filed: Nov. 28, 2017

Related U.S. Application Data
(60) Provisional application No. 62/497,625, filed on Nov. 28, 2016.

(51) Int. Cl. B60K 6/24; B60K 6/46; B60K 6/26; H02K 7/18; H02K 11/04

(52) U.S. Cl. CPC B60K 6/24; B60K 6/46; B60K 6/26; B60Y 2400/60; H02K 11/046; B60Y 2200/92; B60Y 2400/431; H02K 7/1823

(57) ABSTRACT

An auxiliary power system and methods for providing auxiliary power in relation to a vehicle, the system comprising: an auxiliary power unit comprising a compact turbine engine, a generator coupled with the compact turbine engine, and a rectifier unit coupled with the generator, the auxiliary power unit configurable to provide one of an AC output and a DC output; and at least one ancillary component for adapting the auxiliary power unit with an electric drive motor in relation to the vehicle

### CROSS-REFERENCE TO RELATED APPLICATION(S)

This document is a nonprovisional application claiming the benefit of, and priority to, U.S. Provisional Patent Application Ser. No. 62/497,625, entitled “Diesel Turbine-Electric Hybrid Car,” and filed on Nov. 28, 2016, hereby incorporated by reference in its entirety.

### TECHNICAL FIELD

Generally, the present disclosure technically relates to hybrid vehicle technologies. More particularly, the present disclosure technically relates to power system technologies for hybrid vehicles. Even more particularly, the present disclosure technically relates to series power system technologies for hybrid vehicles.

### BACKGROUND

As fossil resources diminish and emissions standards become increasingly strict, transportation technology in the related art is evolving to keep pace with current demands and to provide safe, reliable, and consumer-friendly solutions in automotive engineering. Many related art technologies exclusively focus on either optimizing fuel efficiency and driveline efficiency for existing internal-combustion engine (ICE) vehicles or purely electrically-powered vehicles. Hybrid vehicles remain a small, but still growing minority in the automotive industry. While purely electric vehicles (EVs) have some advantages, in many geographic locations, the infrastructure for supporting EVs is not yet fully developed. Additionally, related art EVs are experience range limitations due to challenges in battery and charging technologies. Further, related art EVs experience other challenges, such as weight, handling, and maintenance in relation to an electric infrastructure, e.g., “the grid,” as well as issues relating to access to knowledgeable technicians by an end-user.

In the related art, hybrid vehicles provide an interim solution for performance and environmental issues lying somewhere between an entirely fossil-fueled vehicle and an entirely electric vehicle, thereby allowing the consumer some level of comfort and convenience associated with fossil-fueled vehicles as well as some short-range benefits of an electric vehicle. In doing so, hybrid vehicles ameliorate some of the major drawbacks of EVs, such as weight arising from a potential reduction in battery size as well as reduction of lengthy charging times for longer trips, wherein the performance and energy-efficiency of electric drives are combined with the local power generation and energy density of fossil-fuel power plants. As such, a variety of related art concepts for hybrid powertrains have been offered by various manufacturers; however, most related art concepts are categorized into two basic types: “parallel” hybrids and “series” hybrids.

With respect to related art parallel hybrid vehicles, their propulsion system uses two semi-independent powertrains (one powertrain being an electric motor and one powertrain being an ICE) that are both mechanically linked via a driveshaft of a vehicle. This parallel hybrid configuration provides the vehicle with an acceleration and performance characteristics associated with an EV, e.g., during acceleration, while allowing the ICE to carry most of the load during high-speed operation or a cruising mode, wherein combustion is much more fuel efficient, e.g., relative to acceleration or “stop-and-go” mode. An example of this parallel hybrid configuration is the first-generation Honda® Insight®. However, then Honda® Insight® requires speed-matching the output of the two semi-independent powertrains to smoothly and safely operate.

In particular, the related art parallel hybrid drivetrains are mechanically linked, with the mechanical outputs of any fossil-fueled engine, even with a related art gas-turbine engine, an ICE, or a related art electric drive motor. In related art parallel hybrid vehicles, the fossil-fueled engine and the electric drive motor are connected to a mechanical drive shaft that actuates the drive wheels, thereby adding undue weight and mechanical complexity to such related art vehicles. Further, related art parallel hybrid systems typically use a gas-turbine engine as either as an on-board charger for the energy accumulator unit or a supplemental power source for directly mechanically actuating the drive shaft in conjunction with a second engine directly actuating the drive shaft. For these related art “parallel hybrid” configurations, two types of power plants (usually combustion and electrical) are implemented, both of which require a simultaneous mechanical connection to the drive shaft in order to actuate the drive wheels.

With respect to related art series hybrid vehicles, a mechanical connection is absent between an ICE and a driveshaft, wherein the ICE is solely utilized for generating power to supplement or supplant the battery pack, whereby the series hybrid vehicle may effectively function as an EV vehicle if the battery pack is sufficiently rechargeable during operation thereof. Such related art series hybrid vehicles are also commonly referred to as “extended-range” EVs, as the ICE's sole purpose is to extend the operational reach of the electrical power source without the need to extend the battery pack capacity itself or recharging from a grid source. An example of a related art series hybrid vehicle is the Chevrolet® Volt® which uses a “range extender,” e.g., a local generator used to produce electricity for the electric drive motor once the battery has been drained.

Therefore, a need exists in the related art for improved systems and methods for hybrid vehicles that provide better performance, better fuel economy, better battery rechargeability, and better electric motor efficiency than those of the related art hybrid vehicles.

### SUMMARY

In addressing at least the challenges experienced in the related art, the subject matter of the present disclosure involves an auxiliary power system (APS) and methods for providing auxiliary power to hybrid vehicles, such as series hybrid vehicles as well as “full” hybrid vehicles, e.g., hybrid vehicles that are configured to operate in one mode of: via the ICE, via the electric motor running on the battery, or via a combination of both the ICE and the electric motor. In general, the APS and methods of the present disclosure involve an auxiliary power unit (APU) configured for either installation/integration in a new vehicle or retrofitting an existing vehicle, wherein the vehicle comprises one of a series hybrid vehicle, a full hybrid vehicle, and a fossil-fueled vehicle.

Additionally, the APS of the present disclosure eliminates the related art need to mechanically link both the fossil-fueled engine as well as an electric drive motor to a drive shaft in order to actuate the wheels of a vehicle. In accordance with some embodiments of the present disclosure, in the APS, a fossil-fueled engine as well as an electric drive motor are electrically linked, wherein the related art mechanical link is eliminated. Instead of using the related art cumbersome mechanical link, the APS of the present disclosure has an electrical link configuration, wherein a generator provides electrical energy for operation of a main electric drive motor, wherein the generator operates in parallel with an on-board energy accumulator, such as a battery unit, wherein a single mechanical input, comprising a single main electric drive motor, is coupled with the drive shaft for actuating the wheels of the vehicle.

In accordance with embodiments of the present disclosure, the term “parallel” refers to the APS simultaneously using both (a) an energy accumulator (battery) and (b) an APU, comprising (1) a compact turbine engine and (2) a generator in a series configuration, for powering a main electric drive motor, wherein (a) and (b) operate in “parallel” in relation to one another, and wherein (b)(1) and (b)(2) operate in “series” in relation to one another. This present disclosure configuration overcomes many of the related art challenges.

In accordance with some embodiments of the present disclosure, the APS comprises an APU having a functional rectifier circuit configured to produce a variable power output which at least matches the vehicle's requirements, thereby extending the range of vehicle, such as beyond that of a typical EV, e.g., the Fiat® 500e®, or a hybrid vehicle solely operating under electrical power, e.g., beyond approximately 75 miles. The APU also comprises a compact turbine engine that provides an economic, efficient, alternative fossil-fuel option that is configured to function as at least one of: a sole power source, an alternative power source, a backup power source in relation to the battery system, and as a recharging power source for a battery system, whereby the battery-only range is extendable to a range approximating that of an exclusively fossil-fueled vehicle, e.g., having an ICE.

In accordance with some embodiments of the present disclosure, the APS, comprising the APU, is configured to operate as a main power system and driveline when retrofitted into an existing vehicle, wherein the APU comprises a compact turbine engine, a generator, and a rectifier unit operable via, a rectifier circuit. For retrofitting a vehicle, the APS further comprises at least one ancillary component for effecting a vehicle conversion, such as a battery pack, an electric drive motor, and a motor controller. The compact turbine engine is configured to operate via at least one fuel of the following: kerosene, JP-7, JP-8, Jet-A1, diesel, such as regular “#2” diesel, and biodiesel. The compact turbine engine is coupled, in a series configuration, with an electric motor configured to operate as an alternating current (AC) generator (an effective custom generator); and the generator is coupled with the rectifier unit, wherein the rectifier unit provides electricity to charge the battery pack for directly powering the electric drive motor directly, whereby an EV is convertible to a series hybrid vehicle.

In accordance with some embodiments of the present disclosure, the compact turbine engine comprises high power-to-weight ratio, a compact size, and an ability to operate on a variety of different fuel types, relative to conventional vehicles. The APU, comprising the turbine engine and the effective custom generator, is a more compact and lightweight than any other related art automotive engine having a similar power output. The compact turbine engine of the present disclosure is configured to accept diesel fuel which is available at most commercial gas stations, whereby the vehicle is enabled for long-term idle or running at its optimal speed. Power may be continuously drawn from the effective custom generator (torque-controlled), whereby up to approximately 15 kW of power is provided to the electric drive motor. By example only, in a test vehicle, this power draw translates to a maximum current supply of approximately 85 A at a nominal operating voltage of approximately 176V which is more than sufficient for standard driving performance and even for acceleration requirements.

In accordance with an embodiment of the present disclosure, an auxiliary power system for providing auxiliary power in relation to a vehicle, the system comprising: an auxiliary power unit comprising a compact turbine engine, a generator coupled with the compact turbine engine, and a rectifier unit coupled with the generator, the auxiliary power unit configurable to provide one of an AC output and a DC output; and at least one ancillary component for adapting the auxiliary power unit with an electric drive motor in relation to the vehicle.

In accordance with an embodiment of the present disclosure, a method of fabricating an auxiliary power system for providing auxiliary power in relation to a vehicle, the method comprising: providing an auxiliary power unit, providing the auxiliary power unit comprising providing a compact turbine engine, providing a generator coupled with the compact turbine engine, and providing a rectifier unit coupled with the generator, and providing the auxiliary power unit comprising configuring the auxiliary power unit to provide one of an AC output and a DC output; and providing at least one ancillary component for adapting the auxiliary power unit with an electric drive motor in relation to the vehicle.

In accordance with an embodiment of the present disclosure, a method of providing auxiliary power in relation to a vehicle by way of an auxiliary power system, the method comprising: providing the auxiliary power system, comprising: providing an auxiliary power unit, providing the auxiliary power unit comprising providing a compact turbine engine, providing a generator coupled with the compact turbine engine, and providing a rectifier unit coupled with the generator, and providing the auxiliary power unit comprising configuring the auxiliary power unit to provide one of an AC output and a DC output; and providing at least one ancillary component for adapting the auxiliary power unit with an electric drive motor in relation to the vehicle; performing one of installing, integrating, and retrofitting the auxiliary power system in relation to the vehicle; and operating the vehicle

Some of the features in the present disclosure are broadly outlined in order that the section, entitled Detailed Description, is better understood and that the present contribution to the art by the present disclosure is better appreciated. Additional features of the present disclosure are described hereinafter. In this respect, understood is that the present disclosure is not limited in its implementation to the details of the components or steps as set forth herein or as illustrated in the several figures of the Drawing, but are capable of being carried out in various ways which are also encompassed by the present disclosure. Also, understood is that the phraseology and terminology employed herein are for illustrative purposes in the description and are not regarded as limiting.

### BRIEF DESCRIPTION OF THE DRAWING

The above, and other, aspects, and features, of the several embodiments in the present disclosure will be more apparent from the following Detailed Description as presented in conjunction with the following several figures of the Drawing.

FIG. 1 is a diagram illustrating a perspective view of a compact turbine engine, in accordance with an embodiment of the present disclosure.

FIG. 2 is a diagram illustrating a perspective view of the compact turbine engine, as shown in FIG. 1, coupled with a generator, in accordance with an embodiment of the present disclosure.

FIG. 3 is a diagram illustrating a perspective view of an electric drive motor coupled with a stock transmission via an adapter plate, in accordance with an embodiment of the present disclosure.

FIG. 4A is a diagram illustrating a perspective view of a battery pack in relation to a vehicle, in accordance with an embodiment of the present disclosure.

FIG. 4B is a diagram illustrating a close-up perspective view of a battery pack in relation to a vehicle, in accordance with an embodiment of the present disclosure.

FIG. 5A is a diagram illustrating a perspective view of an APS, comprising the APU, implemented in relation to a vehicle, in accordance with an embodiment of the present disclosure.

FIG. 5B this diagram illustrating a perspective view of a cargo space of a vehicle for accommodating a main battery pack, in accordance with an embodiment of the present disclosure.

FIG. 6 is a table illustrating an overview of the main performance characteristics for some example components of the APU, in accordance with some embodiments of the present disclosure.

FIG. 7 is a block diagram illustrating a main power system of a vehicle, in accordance with some embodiments of the present disclosure.

FIG. 8 is a table illustrating the performance characteristics for pre-APU retrofit vehicles and post-APU retrofit vehicles, as well as comparisons among different variations of such vehicles having different engine types, in accordance with some embodiments of the present disclosure.

FIG. 9 is a circuit diagram illustrating an auxiliary power system circuit, comprising a rectifier circuit for a rectifier unit, by which an APS, comprising an APU, in accordance with an embodiment of the present disclosure.

FIG. 10A is a diagram illustrating a perspective view of a turbine shaft coupler configured to couple an output shaft of a compact turbine engine with an input shaft of a generator, in accordance with an embodiment of the present disclosure.

FIG. 10B is a diagram illustrating a side view of a turbine shaft coupler configured to couple an output shaft of a compact turbine engine with an input shaft of a generator, in accordance with an embodiment of the present disclosure.

FIG. 10C is a diagram illustrating a rear view of a turbine shaft coupler configured to couple an output shaft of a compact turbine engine with an input shaft of a generator, in accordance with an embodiment of the present disclosure.

FIG. 11 is a flow diagram illustrating a method of fabricating an APS for providing auxiliary power to an electric drive motor of a vehicle, in accordance with an embodiment of the present disclosure.

FIG. 12 is a flow diagram illustrating a method of providing auxiliary power to an electric drive motor of a vehicle by way of an APS, in accordance with an embodiment of the present disclosure.

Corresponding reference numerals or characters indicate corresponding components throughout the several figures of the Drawing. Elements in the several figures are illustrated for simplicity and clarity and have not necessarily been drawn to scale. For example, the dimensions of some elements in the figures are emphasized relative to other elements for facilitating understanding of the various presently disclosed embodiments. Also, well-understood elements that are useful or necessary in commercially feasible embodiment are often not depicted to facilitate a less obstructed view of these various embodiments of the present disclosure.

### DETAILED DESCRIPTION

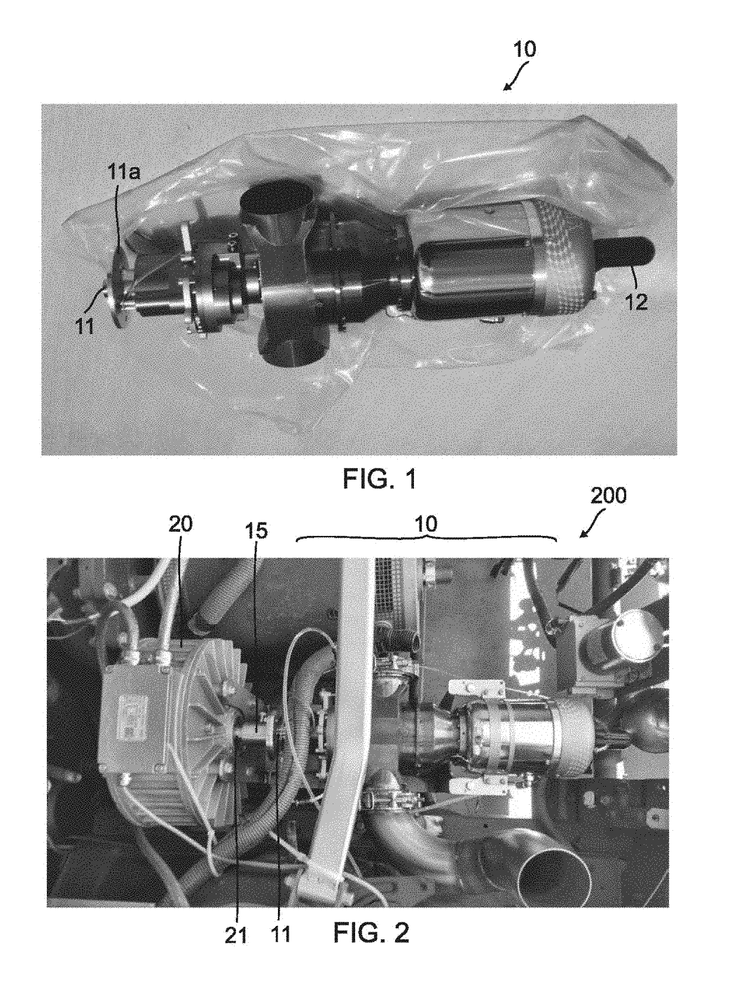

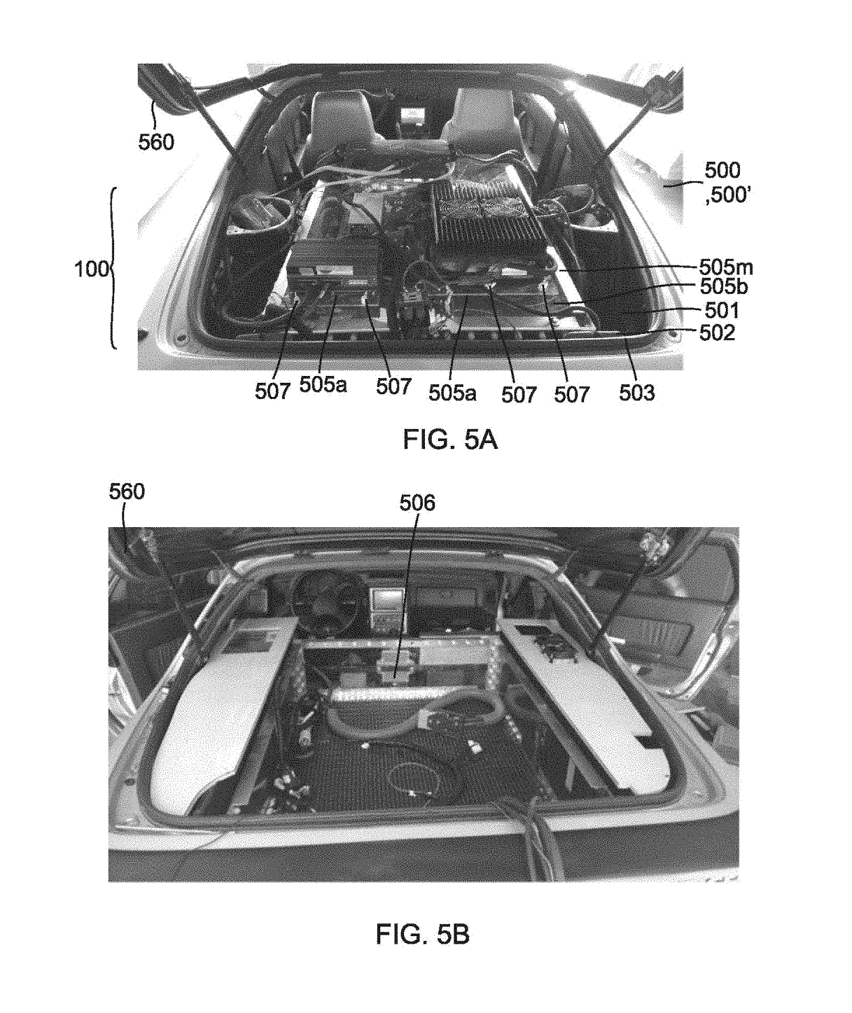

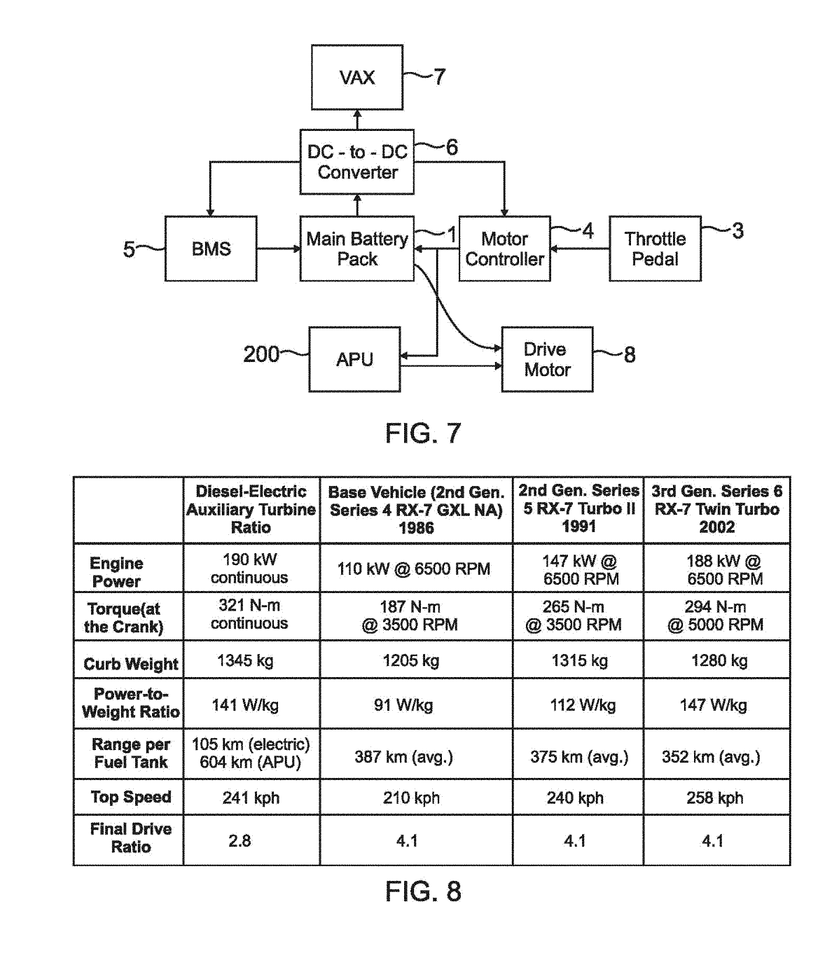

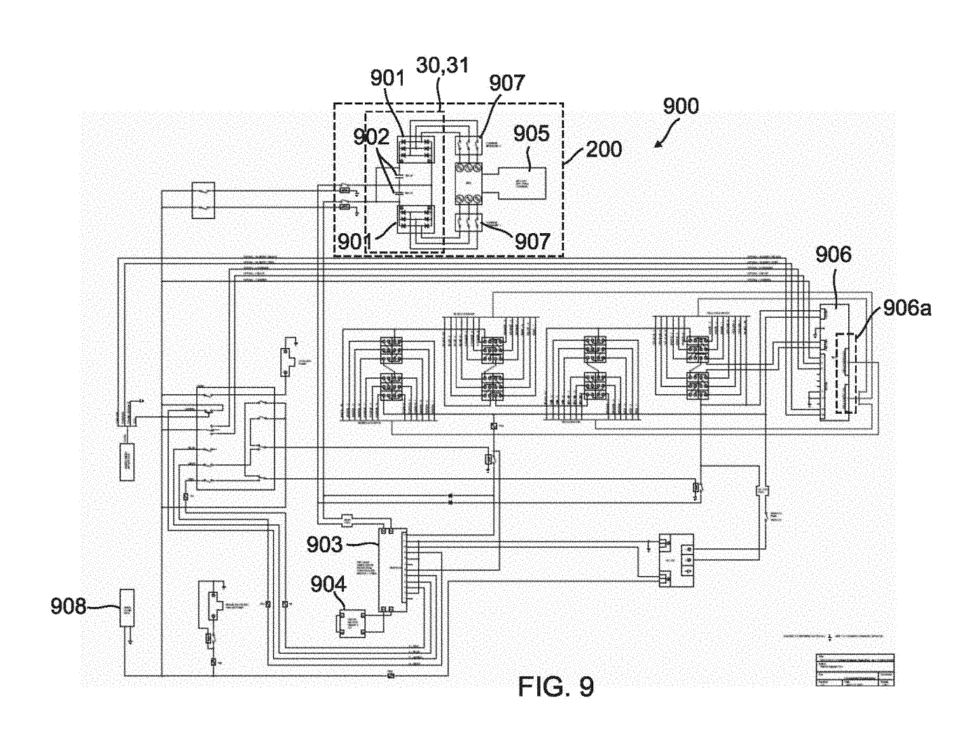

Referring to FIG. 1, this diagram illustrates, in a perspective view, a compact turbine engine 10, in accordance with an embodiment of the present disclosure. An APU 200 comprises a compact turbine engine 10, a generator 20 (FIG. 2), and a rectifier unit 30 (FIG. 9). The APU 200 is retrofittable in relation to a vehicle 500 (FIGS. 4A-5), whereby the vehicle 500 is converted to a series hybrid vehicle 500′. As such, the APU 200 is configurable as a standalone unit capable of providing auxiliary power for use with any electric drive motor, e.g., a drive motor 8 (FIG. 7), requiring up to approximately 380V AC or approximately 380V DC as well as up to approximately 15 kW of power. By example only, the compact turbine engine 10 comprises a JetCat® SPT15-RX gas-turbine turboprop engine having a gear reduction of approximately 14.1:1; the generator 20 comprises a custom Heinzmann® PMS-150 permanent-magnet synchronous generator; and the rectifier unit 30 comprises a custom full-wave rectifier and rectifier circuit, the rectifier circuit comprising a capacitance circuit.

Still referring to FIG. 1, the compact turbine engine 10 comprises an output shaft 11. The APU 200, comprising the compact turbine engine 10, is compact, self-contained, and configured to provide either an AC output or a DC output. The compact turbine engine 10, comprising the JetCat® SPT15-RX gas-turbine turboprop engine 905 (FIG. 7), having a gear reduction of approximately 14.1:1, has a modified core configured to operate with at least one of diesel fuel and biodiesel fuel. Further, the compact turbine engine 10 is configured to operate using a lubricant additive, such as a silicone-based lubricant additive, for enhancing certain operating conditions. The lubricant additive is used when running the compact turbine engine 10 on lighter hydrocarbon fuel, such as kerosene, JP-7, JP-8, and Jet-A1, wherein the ratio of the lubricant additive to the fuel is approximately 1:20. When running the compact turbine engine 10 on diesel, e.g., a “#2” diesel fuel, being a sufficiently heavy fuel, a lubricant additive is not required, but may be optionally used for long term durability, wherein the ratio of the lubricant additive to the fuel comprises a range of approximately 1:20 to approximately 1:80, and wherein the ratio of the lubricant additive to the fuel preferably comprises approximately 1:20, whereby the compact turbine engine 10 provides a nominal power output of approximately 15 kW. The compact turbine engine 10 has an optimal fuel consumption at approximately 75,000 RPM, and a maximum safe power output at approximately 132,000 RPM. The compact turbine engine 10 has a gearbox reduction of approximately 14.1:1 forward of the gas-turbine output shaft 11 and is capable of providing torque of approximately 32.7 N-m at its final drive ratio.

Referring to FIG. 2, this diagram illustrates, in a perspective view, the compact turbine engine 10, as shown in FIG. 1, coupled with a generator 20, in accordance with an embodiment of the present disclosure. The APU 200 comprises a compact turbine engine 10, a generator 20, and a rectifier unit 30 (FIG. 9). The generator 20 comprises a generator input shaft 21. The gas-turbine output shaft 11 is coupled with the input shaft 21 of the generator 20, comprising a permanent magnet generator, such as a synchronous permanent magnet generator, with a three-phase AC electric output, e.g., a custom Heinzmann® GmbH two-stage, by way of a turbine shaft coupler 15. The generator 20 is configured to provide power of up to approximately 60 kW at maximum torque load, and, as such, is configured to handle a potentially more powerful compact turbine engine 10 or a heavier vehicle 500, wherein the generator 20 is enabled to handle a maximum torque load of up to approximately 32.5 N-m at an engine speed of approximately 6000 RPM.

Still referring to FIG. 2, the generator 20 comprises at least one generator stage (not shown). For example, the at least one generator stage comprises a plurality of generator stages, such as two generator stages, that are routed through the rectifier unit 30. The rectifier unit 30 (FIG. 9) comprises a rectifier circuit 31 (FIG. 9), wherein the rectifier circuit 31 comprises at least one corresponding, or separate, full-wave rectifier circuit 901 (FIG. 9), such as a full-wave bridge rectifier, configured to handle a current of approximately 400 A at voltage of approximately 100 V and to generate a DC output. The resulting DC output from each at least one corresponding full-wave rectifier circuit 901, e.g., the full-wave bridge rectifier, is further filtered through a corresponding capacitor 902, such as a 20,000-μF capacitor, wherein corresponding capacitor 902 reduces any voltage ripple prior to transmitting energy to a primary power system, such as the main power system 700 (FIG. 7) of the vehicle, such as the vehicle 500′ (FIG. 5A), in parallel with transmitting energy to the battery pack, such as the main battery pack 1 (FIG. 7).

Still referring to FIG. 2, the generator 20, comprising the permanent magnet generator, has an output voltage that is configured to directly correlate with the engine speed of an input shaft, such as the gas-turbine output shaft 11, thereby allowing for precise voltage control. An APS 100 (FIGS. 4A-5), comprising the APU 200, is operable via an auxiliary power system circuit 900 (FIG. 9), wherein the auxiliary power system circuit 900 comprises the rectifier unit 30, and wherein the rectifier unit 30 comprises the rectifier circuit 31. By example only, the rectifier circuit 31 comprises a three-phase bridge rectifier circuit.

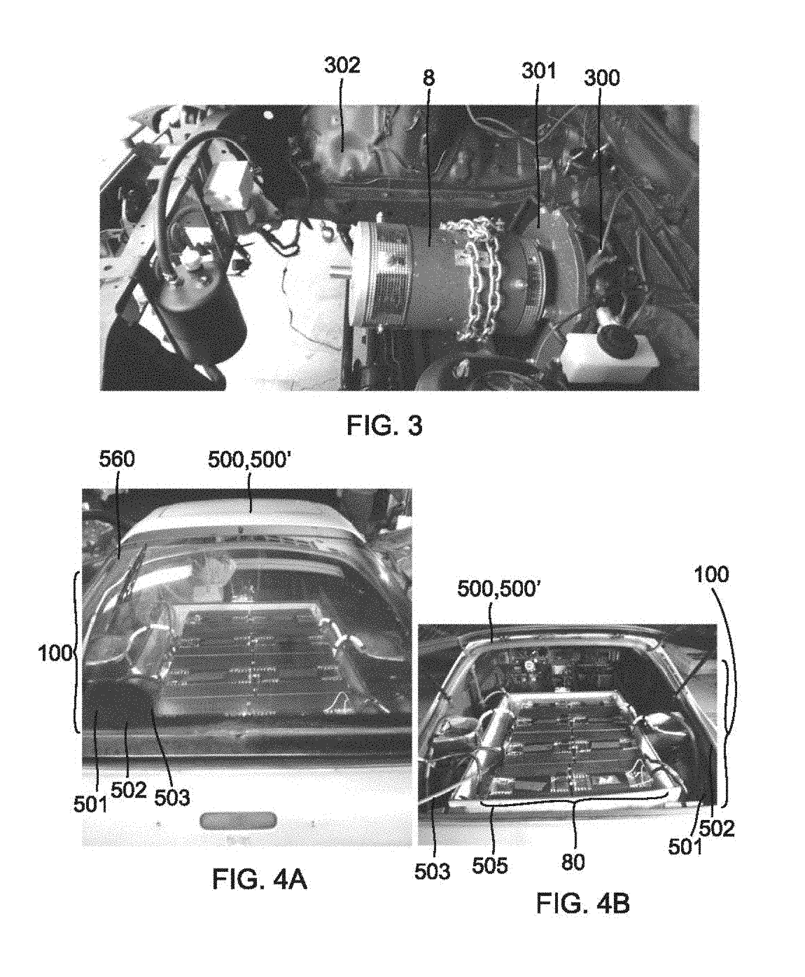

Referring to FIG. 3, this diagram illustrates, in a perspective view, an electric drive motor, such as a drive motor 8 (FIG. 7), coupled with a stock transmission 300 via an adapter plate 301, in accordance with an embodiment of the present disclosure. For example, a base vehicle, such as the vehicle 500, usable in a conversion by way of the system 100, comprises a lightweight vehicle, such as an economy car and a sportscar. By example only, the vehicle 500 comprises a 1986 Mazda® RX-7® GXL®, such as the FC3S® chassis model. For hybridization, or conversion, of the vehicle 500 into a vehicle 500′, modifications are performed which include removing at least one original equipment manufacturer (OEM) component, such as an OEM rotary engine, an OEM exhaust system, an OEM electronics harness, an OEM radiator, an OEM starter, and an OEM alternator.

Still referring to FIG. 3, the conversion further comprises installing at least one ancillary component, such as the electric drive motor, e.g., the drive motor 8, wherein the electric drive motor comprises a Netgain® Warp 9® or Warp 7® HV® high-voltage DC brushed electric motor 904, by example only. The vehicle 501 retains the OEM firewall, e.g., a firewall 302, disposed between the engine compartment and the passenger compartment for providing safe thermal insulation. The electric drive motor, e.g., the drive motor 8, is coupled, e.g., directly, with the stock transmission 300 via the adapter plate 301, wherein the adapter plate 301 is configured to accommodate a clutch (not shown), and wherein the stock transmission 300 comprises an OEM transmission, e.g., a 5-speed manual transmission, whereby the vehicle 500′ remains operable with an OEM 5-speed gear shifter, including the reverse gear shifter, whereby any need for an electronic reverse switch is eliminated, whereby the electric drive motor comprises an operational range exceeding that of an OEM fossil-fueled engine, e.g., the OEM rotary engine, having a redline engine speed of approximately 5000 RPM at a high vehicle speed, corresponding to the vehicle's top speed in its highest gear, e.g., approximately 140 mph, and whereby the electric drive motor maintains better torque and acceleration at a low vehicle speed as relative to a drive motor having a single-speed drive, e.g., compared with a single-speed electric drive in a range of approximately 0 to approximately 30 mph. The high vehicle speed comprises a range that is at least that of the OEM vehicle, such as a range of approximately 129 mph to approximately 175 mph. The electric drive motor comprises a redline motor speed comprises a range of approximately 4000 RPM to approximately 12000 RPM, whereby the transmission is operable in low gears, e.g., gears 1, 2, and 3 of the 5-speed manual transmission. The turbine shaft power output comprises a range of at least approximately the minimum turbine shaft power output required to produce approximately 50 A of electric power at a nominal drive voltage of approximately 176 V, such as a range of approximately 8.8 kW to approximately 25 kW, while limiting size and weight of the compact turbine engine 10 operating in a, engine speed range of approximately 50,000 to approximately 150,000 RPM. The generator 20 operates at a generator speed (in RPM) and at a torque that have ranges corresponding to the output and gear reduction ratio the compact turbine engine 10.

Referring to FIGS. 4A and 4B. together, these diagrams respectively illustrate, in a perspective view and a close-up perspective view, a battery pack, such as the main battery pack 1 (FIG. 7), in relation to a vehicle 500′, in accordance with an embodiment of the present disclosure. The hybridization, or conversion, of the vehicle 500 further comprises: removing other components from the trunk, or cargo space, 501, thereby leaving a bare chassis 502; and lining the bare chassis 502 with an electrically insulating rubber sheeting 503. The hybridization, or conversion, further comprises: installing at least one battery coupler 504, e.g., at least one battery mount 505m (FIG. 5A), for coupling a battery box 505; installing at least one support strut 506 (FIG. 5B), wherein installing the at least one support strut 506 comprises welding the at least one support strut 506 to an interior portion of the bare chassis 502.

Still referring to FIGS. 4A and 4B. together, the system 100 further comprises the battery pack, e.g., the main battery pack 1, disposable in the cargo space, 501 of the vehicle 500′, e.g., extending from behind the driver seat and passenger seat to an aft section of the vehicle 500′, thereby allowing direct access via an access component, such as a rear hatch, or hatch-door 560 (FIG. 5A). By example only, the main battery pack 1 comprises an eight-module battery pack 80, wherein the eight-module battery pack 80 comprises a customized Enerdel® 6s8p nickel-manganese-cobalt (NMC) set of cells, having a total weight, including the battery box 505, of approximately 115 kg and a total capacity of approximately 25 kWh. The APS 100, comprising the APU 200, further comprises a battery management system (BMS) 906 (FIG. 7), such as an Orion® BMS, utilizing approximately 48 cell taps 906a and a Hall-effect current sensor (not shown) in relation to a positive cable (not shown) of the main battery pack 1, for monitoring thereof.

Referring to FIG. 5A, this diagram illustrates, in a perspective view, an APS 100, comprising the APU 200, implemented in relation to a vehicle 500′, in accordance with an embodiment of the present disclosure. The battery box 505 comprises a polymer material, such as a polycarbonate material. By example only, the polycarbonate material comprises a plurality of Lexan® polycarbonate material sheets 505a, e.g., having a thick ness of approximately 12.7 ram. The Lexan® polycarbonate material sheets are coupled together by at least one fastener 507, e.g., via “217” insulating nylon bolts, wherein each bolt is configured to withstand a shear load of approximately 220-N. For example, the BMS 5 (FIG. 7), a motor controller 4 (FIG. 7), a charger (not shown), and other ancillary components are mountable in relation to, e.g., on top of, the battery box 505, such as with a battery box lid 505b, by at least one fastener 507, in relation to separate Lexan® polycarbonate material sheets 505a for electrical protection. Alternatively, the ancillary components are mountable away from the top f the battery box 505, e.g., in secure and accessible compartments, to eliminate any stress on the lid 505b.

Still referring to FIG. 5A, in hybridization, or conversion, a 12-V electrical system of the vehicle 500 may remain; however, a pre-existing lead-acid car battery is replaced with a converter, such as a 635-W DC-to-DC converter 6 (FIG. 7), configured to directly draw current from the battery pack 1. The DC-to-DC converter 6 provides power to all auxiliary 12-V functions of the vehicle 500′, and to the BMS 5, the motor controller 4, and an electric drive control (not shown), such as a Hall-effect throttle unit (not shown) in the engine compartment (not shown), mechanically actuated by the original throttle cable (not shown) and a pedal assembly, such as a throttle pedal 3 (FIG. 7). Drive power is regulated by the motor controller 4, e.g., the Netgain® Warp-Drive® industrial motor controller (WDIC) 903, having a total voltage capacity of approximately 300 V and a total current capacity of approximately 1400 A.

Still referring to FIG. 5A, hybridization, or conversion, further comprises mounting the APU 200 adjacent the drive motor 8 (FIG. 2) in the engine compartment, e.g., in the empty space vacated by removing the OEM fossil-fueled engine (not shown). The AC output from the APU 200 is handled by a set of 200-A AC breakers, such as a set of turbine breakers 907 (FIG. 9), forward of the rectifier circuit 31 and aft of the firewall 302 (FIG. 3), proceeding from there to be connected in parallel with the battery pack, e.g., the battery pack 1. For the compact turbine engine 10, startup, speed control, and monitoring may be handled via an external handheld ground station unit (GSU) (not shown), although any other turbine handling unit may be implemented and is encompassed by the present disclosure, thereby allowing turbine startup even when the vehicle is moving, whereby the weight of the drive motor 8 and APU 200 in a front engine compartment (not shown) is balanced by the weight of the battery pack 1 and auxiliary electrical components in the cargo compartment 501, with the main weight of each section resting over each axle (not shown) of the vehicle 500′. Other turbine handling units comprise a laptop or tablet controlling the turbine electronic control unit (ECU), as well as any built-in control that achieve the same result, e.g., eliminating a handheld unit and rewiring the other turbine control unit into a dashboard switch cluster.

Referring to FIG. 5B, this diagram illustrates, in a perspective view, the cargo space, 501 of the vehicle 500′, e.g., extending from behind the driver seat and passenger seat to an aft section of the vehicle 500′ for accommodating the main battery pack 1, in accordance with an embodiment of the present disclosure. As discussed, the hybridization, or conversion, further comprises: installing at least one battery coupler 504, e.g., at least one battery mount 505m (FIG. 5A), for coupling a battery box 505; installing at least one support strut 506, wherein installing the at least one support strut 506 comprises welding the at least one support strut 506 to an interior portion of the bare chassis 502.

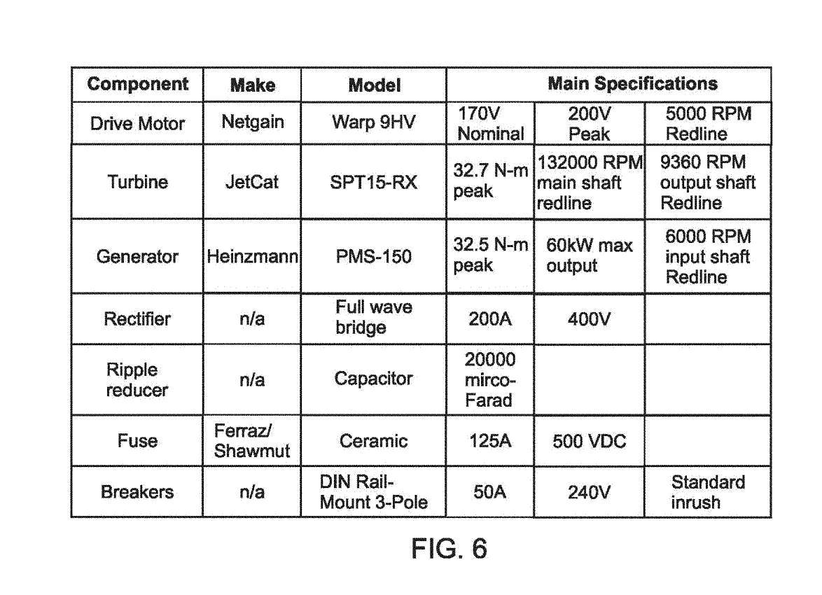

Referring to FIG. 6, this table illustrates an overview of the main performance characteristics for some example components of the APU 200, in accordance with some embodiments of the present disclosure. Some components, such as the bridge rectifiers, capacitors, and AC breakers, are herein generally disclosed; however, each such component may also be modified to suit particular specifications for a particular implementation, e.g., to suit a particular set of conversion circumstances for a particular make and model of the vehicle 500 or to achieve a particular set of performance characteristics. The APS 100 in the vehicle 500′ has a safety factor of at least approximately 2.0 in relation to each component.

Referring to FIG. 7, this block diagram illustrates a main power system 700, e.g., as included in the APS 100, of a vehicle 500′, in accordance with some embodiments of the present disclosure. The main power system 700 comprises: a main battery pack 1; the APU 200; the throttle pedal 3; the motor controller 4; the BMS 5; the DC-to-DC converter 6; the vehicle auxiliary systems (VAX) 7, wherein the VAX 7 comprises at least one of headlights (not shown), a horn (not shown), a brake booster (not shown), brake lights (not shown), etc.; and the drive motor 8. The throttle pedal 3 actuates the motor controller 4; and the motor controller 4 activates the main battery pack 1 and transmits energy to the APU 200. The main battery pack 1 transmits energy to the DC-to-DC converter 6, and wherein converted voltage from the converter 6 powers the VAX 7, the motor controller 4. Also, energy is transmitted back to the main battery pack 1 from the motor controller 4 and the BMS 5. The main battery pack 1 powers the drive motor 8; and the APU 200 provides auxiliary power to the drive motor 8.

Still referring to FIG. 7, more specifically, the main battery pack 1 supplies power to both the drive motor 8 as well as all the VAX 7 via the DC-to-DC converter 6, such as a stepdown transformer. The power from the main battery pack 1 to the drive motor 8 is regulated by the motor controller 4, receiving input from the throttle pedal 3. The main battery pack 1 is maintained and protected by the BMS 5, wherein the BMS 5 protects the main battery pack 1 from overly high current outputs and current inrush during charging as well as balances the individual cells of the main battery pack 1 for optimal health, lifespan, and performance. This main power system 700 generally comprises the operational components if the vehicle 500′ when operating in an all-electric mode, e.g., via the system circuit 900 (FIG. 9).

Still referring to FIG. 7, when the vehicle 500′ is operating in hybrid mode, the compact turbine engine 10 of the APU 200 is activated and coupled with other components of the main power system 700 by a safety relay (FIG. 9), with a set of diodes preventing current backflow into the APU 200 or the main battery pack 1. The AC output from the APU 200 is converted into DC current, the amplitude of which can be regulated by turbine speed, and filtered and further regulated by a pair of 20,000-μF capacitors 902 before connecting to the main power system (FIG. 9). At this stage, the APU 200 receives the majority load of the main power system 700 and the drive load from the main battery pack 1, thereby relegating the main battery pack 1 to powering the VAX 7.

Still referring to FIG. 7, the APU 200 is connected in parallel to the main battery pack 1 in the main power system 700, thereby allowing the main power system 700 to share load and to charge the main battery pack 1 if necessary. The parallel connection also allows the vehicle 500′ to be driven solely on the APU 200 if required. Regardless of operational mode, all auxiliary systems are powered by the main battery pack 1 via the DC-to-DC converter 6 configured to operate with an input voltage in a range of approximately 120 to approximately 240V, thereby allowing the DC-to-DC converter 6 to maintain a constant 12-V output for the auxiliary systems even if the main battery pack 1 is depleted beyond its capability to drive the vehicle 500′. Auxiliary systems comprise the BMS 5, motor controller 4, safety contactors (FIG. 9), and vehicle ancillary systems (not shown), such as headlights, horn, turn indicators, brake lights, and brake booster. The ancillary systems of the vehicle 500′ do not require alteration or modification in any form to implement the hybridization, or conversion, beyond the main fuse box 908 (FIG. 9). Power to the main fuse box 908 is delivered by the DC-to-DC converter 6 instead of a related art 12-V car battery. Turbine controls, startup, and ignition are powered by a separate 10-V power supply in the vehicle 500′ that operates independently of the main battery pack 1.

Referring to FIG. 8, this table illustrates the performance characteristics for pre-APU retrofit vehicles and post-APU retrofit vehicles, as well as comparisons among different variations of such vehicles having different engine types, in accordance with some embodiments of the present disclosure. The hybridized or converted vehicle 500′ having the APS 100, comprising the APU 200, is compared with its corresponding OEM base model, its corresponding OEM turbo-charged model, and its corresponding OEM later model, e.g., of its line produced many years later. The fuel consumption and range estimates for all vehicles listed in FIG. 8 are estimates based on “high” values and “low” values provided by the U.S. Environmental Protection Agency (EPA), the manufacturers, and the reported data. Range estimates for the vehicle 500′ are based on ERD Engineering® testing conducted over a period of one year on varying routes, driving conditions, as well as in varying traffic conditions, e.g., ranging from freeway to city and traffic jam driving.

Still referring to FIG. 8, while the overall curb weight of the vehicle 500′ may be increased by approximately 150 kg, the vehicle 500 ultimately has a higher power-to-weight ratio than both the base model and its turbo-charged contemporary of the vehicle 500, whereby the engine's power output is increased, and whereby the electric drive motor 8 produces constant, near-maximum, torque and constant, near-maximum, power across an operational band in a range of approximately 0 RPM to approximately 3500 RPM before performance is degradable at a redline engine speed. The vehicle 500′ has a power-to-weight ratio, power, torque outputs, and a top speed at least comparable to the OEM vehicle. Fuel mileage varies depending on driving conditions. However, the vehicle 500′ has averaged a range of approximately 105 km while operating solely in an all-electric mode and is, thus, competitive with current plug-in electric and plug-in hybrid vehicles. The vehicle 500′, with the APU 200, operating on a full alternative fuel tank, having a size approximating an OEM fuel tank, can reach a range of approximately 600 kin, e.g., beyond related art EVs in its class.

Still referring to FIG. 8, the vehicle 500′, with the APU 200, is a full hybrid. As such, the vehicle 500′ is competitive in relation to several related art series hybrid vehicles and powertrains, such as the Chevrolet® Volt® and Fisker® Karma®, as well as the Toyota® Prius®, Camry® Hybrid, Ford® Escape® Hybrid, Mercury® Mariner® Hybrid, Kia® Optima® Hybrid, and the like. Thus, the vehicle 500′, with the APU 200, is also capable of operating by both types of power systems, having the performance and efficiency of electric motors and battery packs during acceleration; and having the generation efficacy of internal combustion engines when running at their optimal, constant speed.

Still referring to FIG. 8, the vehicle 500′, with the APU 200, comprises features, such as the compact turbine engine 10, e.g., a compact gas turbine engine, whereby an increased power-to-weight ratio is provided, and whereby use of a related art ICE is eliminated. The APU 200 installed in the vehicle 500′ is more compact and lightweight relative to comparable ICEs having a comparable power output and, yet, maintains the ability to operate on readily available commercial fuel, such as #2 diesel. The generator 20, comprising a torque-load controlled generator, allows the turbine of the engine 10 to spin at its optimal speed for best fuel consumption while also providing sufficient power to allow the vehicle 500′ to operate solely on the APU 200, or to act as a power booster, if necessary, when operating in an all-electric mode. The APS 100, comprising the APU 200 using the compact turbine engine 10, e.g., a gas-turbine engine, structurally and functionally streamlines the intake system, the cooling system, and the exhaust system of the vehicle 500′, wherein the APU 200 is lighter in weight and streamlined in complexity relative to a related art ICE.

Referring to FIG. 9, this circuit diagram illustrates an auxiliary power system circuit 900, comprising a rectifier circuit for a rectifier unit 30, by which an APS 100, comprising an APU 200, is operable, in accordance with an embodiment of the present disclosure. As discussed in relation to FIG. 2, the rectifier unit 30 comprises a rectifier circuit 31, wherein the rectifier circuit 31 comprises at least one corresponding, or separate, full-wave rectifier circuit 901, e.g., the full-wave bridge rectifier or the three-phase bridge rectifier, configured to handle a current of approximately 400 A at voltage of approximately 1000 V and to generate a DC output. The resulting DC output from each at least one corresponding full-wave rectifier circuit 901, e.g., the full-wave bridge rectifier, is further filtered through a corresponding capacitor 902, such as a 20,000-μF capacitor, wherein corresponding capacitor 902 reduces any voltage ripple prior to transmitting energy to a primary power system, such as the main power system 700 (FIG. 7) of the vehicle, such as the vehicle 500′ (FIG. 5A), in parallel with transmitting energy to the battery pack, such as the main battery pack 1 (FIG. 7).

Still referring to FIG. 9, as discussed in relation to FIGS. 4A and 4B, the APS 100 further comprises a battery management system (BMS) 906, e.g., the Orion® BMS, utilizing approximately 48 cell taps 906a and a Hall-effect current sensor (not shown) in relation to a positive cable (not shown) of the main battery pack 1, for monitoring thereof. As discussed in relation to FIG. 5A, the drive power is regulated by the motor controller 4, e.g., the Netgain® Warp-Drive® industrial motor controller (WDIC) 903, having a total voltage capacity of approximately 300 V and a total current capacity of approximately 1400 A. Hybridization, or conversion, further comprises mounting the APU 200 adjacent the drive motor 8 (FIG. 2) in the engine compartment, e.g., in the empty space vacated by removing the OEM fossil-fueled engine (not shown). The AC output from the APU 200 is handled by a set of 200-A AC breakers, such as a set of turbine breakers 907, forward of the rectifier circuit 31 and aft of the firewall 302, proceeding from there to be connected in parallel with the battery pack, e.g., the battery pack 1.

Still referring to FIG. 9, as discussed in relation to FIG. 7, when the vehicle 500′ is operating in hybrid mode, the compact turbine engine 10 of the APU 200 is activated and coupled with other components of the main power system 700 by a safety relay, with a set of diodes preventing current backflow into the APU 200 or the main battery pack 1. The safety relay comprises a high-voltage relay configured to switch-on and switch-off current flow from the APS 100 as well as from and a high-current fuse.

The AC output from the APU 200 is converted into DC current, the amplitude of which can be regulated by turbine speed, and filtered and further regulated by a pair of 20,000-μF capacitors 902 before connecting to the main power system. At this stage, the APU 200 receives the majority load of the main power system 700 and the drive load from the main battery pack 1, thereby relegating the main battery pack 1 to powering the VAX 7.

Still referring to FIG. 9, as discussed in relation to FIG. 7, the APU 200 is connected in parallel to the main battery pack 1 in the main power system 700, thereby allowing the main power system 700 to share load and to charge the main battery pack 1 if necessary. The parallel connection also allows the vehicle 500′ to be driven solely on the APU 200 if required. Regardless of operational mode, all auxiliary systems are powered by the main battery pack 1 via the DC-to-DC converter 6 configured to operate with an input voltage in a range of approximately 120 to approximately 240V, thereby allowing the DC-to-DC converter 6 to maintain a constant 12-V output for the auxiliary systems even if the main battery pack 1 is depleted beyond its capability to drive the vehicle 500′. Auxiliary systems comprise the BMS 5, motor controller 4, safety contactors, and vehicle ancillary systems (not shown), such as headlights, horn, turn indicators, brake lights, and brake booster. The ancillary systems of the vehicle 500′ do not require alteration or modification in any form to implement the hybridization, or conversion, beyond the main fuse box 908. Power to the main fuse box 908 is delivered by the DC-to-DC converter 6 instead of a related art 12-V car battery. Turbine controls, startup, and ignition are powered by a separate 10-V power supply in the vehicle 500′ that operates independently of the main battery pack 1.

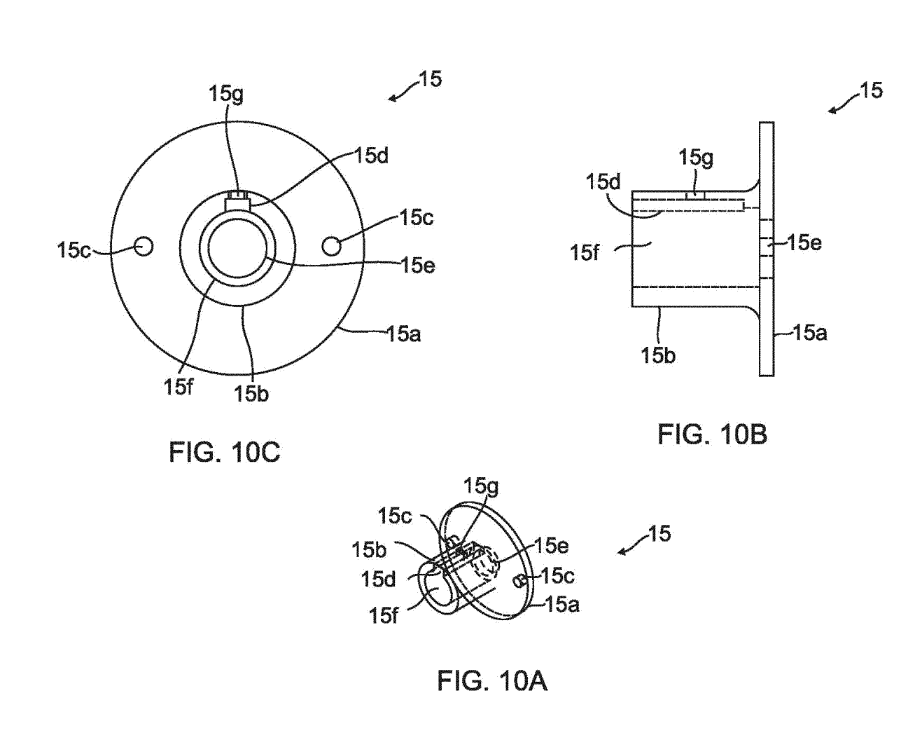

Referring to FIGS. 10A, 10B, and 10C, together, these diagrams respectively illustrate, in a perspective view, a side view, and a rear view, a turbine shaft coupler 15 configured to couple an output shaft 11 of a compact turbine engine 10 with an input shaft 21 of a generator 20 (FIGS. 1 and 2), in accordance with an embodiment of the present disclosure. Exemplary custom dimensions are shown. The turbine shaft coupler 15 comprises a flange portion 15a and a sleeve portion 15b which may be either integrally or separately formed, wherein the sleeve portion 15b is in a concentric relationship with the flange portion 15a.

Still referring to FIGS. 10A, 10B, and 10C, together, the flange portion 15a comprises an orifice 15e having an inner dimension approximating an outer dimension of the output shaft 11, wherein an inner dimension of the orifice 15e has a sufficient tolerance in relation to outer dimension of the output shaft 11. This sufficient tolerance ranges from approximately −0.001 inch to approximately +0.001 inch, and preferably from approximately −0.0005 inch to approximately +0.0005 inch. The flange portion 15a is configured to mate with both the output shaft 11 and an output flange 11a (FIGS. 1 and 22) of the compact turbine engine 10. The sleeve portion 15b is configured to receive the input shaft 21 of the generator 20. The flange portion 15a comprises at least one tap hole 15c for receiving at least one fastener (not shown), whereby the the flange portion 15a and the output flange 11a are fastenable together via the at least one fastener, whereby structural stability is enhanced, and whereby slippage during rotation of the output flange 11a is prevented.

Still referring to FIGS. 10A, 10B, and 10C, together, the sleeve portion 15b comprises at least one channel 15d for facilitating receipt of the input shaft 21. The sleeve portion 15b comprises an orifice 15f having an inner dimension approximating an outer dimension of the input shaft 21, wherein an inner dimension of the orifice 15f has a sufficient tolerance in relation to outer dimension of the input shaft 21. This sufficient tolerance ranges from approximately −0.001 inch to approximately +0.001 inch, and preferably from approximately −0.0005 inch to approximately +0.0005 inch. The sleeve portion 15b comprises at least one through-hole 15g extending from the at least one at least one channel 15d. The at least one through-hole 15g configured to receive at least one fastener, wherein the sleeve portion 15b and the input shaft 21 are fastenable together, whereby structural stability is enhanced, and whereby slippage during rotation of sleeve portion 15b is prevented. Further, the at least one channel 15d may also accommodate a longitudinally projected portion (not shown) of the input shaft 21, whereby structural stability is further enhanced, and whereby slippage during rotation of sleeve portion 15b is further prevented. The at least one through-hole 15g may comprises a threaded feature for receiving at least one fastener (not shown), such as a set screw, a bolt, a machine screw, and the like.

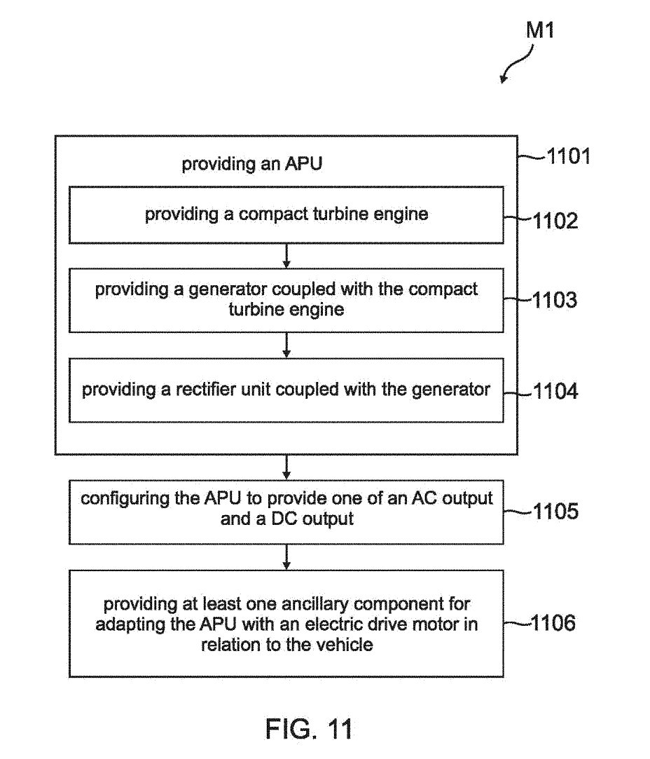

Referring to FIG. 11, this flow diagram illustrates a method M1 of fabricating an APS 100 for providing auxiliary power to an electric drive motor 8 of a vehicle 500′, in accordance with an embodiment of the present disclosure. The method M1 comprises: providing an APU 200, as indicated by block 1101, providing the APU 200 comprising providing a compact turbine engine 10, as indicated by block 1102, providing a generator 20 coupled with the compact turbine engine 10, as indicated by block 1103, and providing a rectifier unit 30 coupled with the generator 20, as indicated by block 1104, and providing the APU 200 comprising configuring the APU 200 to provide one of an AC output and a DC output, as indicated by block 1105; and providing at least one ancillary component (not shown) for adapting the APU 200 with an electric drive motor 8 in relation to the vehicle 500′, as indicated by block 1106.

Still referring to FIG. 11, providing the APU 200, as indicated by block 1101, comprises configuring the APU 200 as retrofittable in relation to a vehicle 500, whereby the vehicle 500 is convertible to a series hybrid vehicle 500′, providing the compact turbine engine 10, as indicated by block 1102, comprises providing a JetCat® SPT15-RX gas-turbine turboprop engine with a gear reduction of approximately 14.1:1, providing the generator 20, as indicated by block 1103, comprises providing a custom Heinzmann® PMS-150 permanent-magnet synchronous generator, and providing the rectifier unit 30, as indicated by block 1104, comprises providing a custom full-wave rectifier and a rectifier circuit 31, the rectifier circuit 31 comprising a capacitance circuit. Providing the compact turbine engine 10, as indicated by block 1102, comprises configuring the compact turbine engine 10 to operate with at least one fuel of kerosene, diesel fuel, and biodiesel fuel.

Still referring to FIG. 11, providing the compact turbine engine 10, as indicated by block 1102, comprises configuring the compact turbine engine 10 to operate using a lubricant additive, such as a silicone-based lubricant additive, for enhancing certain operating conditions. The lubricant additive is used when running the compact turbine engine 10 on lighter hydrocarbon fuel, such as kerosene, JP-7, JP-8, and Jet-A1, wherein the ratio of the lubricant additive to the fuel is approximately 1:20. When running the compact turbine engine 10 on diesel, e.g., a “#2” diesel fuel, being a sufficiently heavy fuel, a lubricant additive is not required, but may be optionally used for long term durability, wherein the ratio of the lubricant additive to the fuel comprises a range of approximately 1:20 to approximately 1:80, and wherein the ratio of the lubricant additive to the fuel preferably comprises approximately 1:20, whereby the compact turbine engine 10 provides a nominal power output of approximately 15 kW. The compact turbine engine 10 has an optimal fuel consumption at approximately 75,000 RPM, and a maximum safe power output at approximately 132,000 RPM. The compact turbine engine 10 has a gearbox reduction of approximately 14.1:1 forward of the gas-turbine output shaft 11 and is capable of providing torque of approximately 32.7 N-m at its final drive ratio.

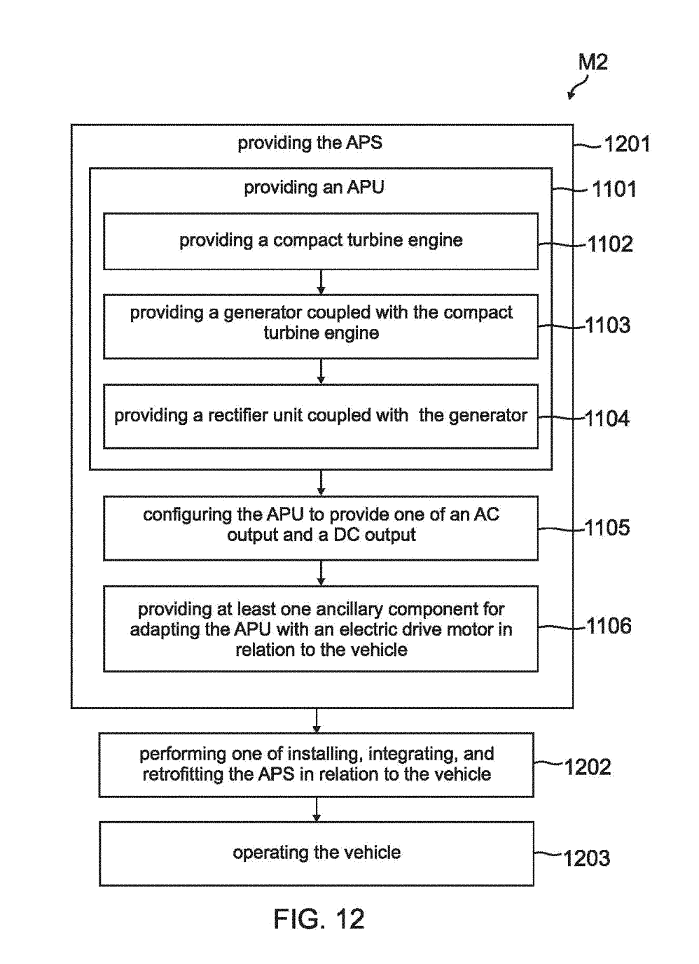

Referring to FIG. 12, this flow diagram illustrates, a method M2 of providing auxiliary power to an electric drive motor 8 of a vehicle 500′ by way of an APS 100, in accordance with an embodiment of the present disclosure. The method M2 comprises: providing the APS 100, as indicated by block 1201, comprising: providing an APU 200, as indicated by block 1101, providing the APU 200 comprising providing a compact turbine engine 10, as indicated by block 1102, providing a generator 20 coupled with the compact turbine engine 10, as indicated by block 1103, and providing a rectifier unit 30 coupled with the generator 20, as indicated by block 1104, and providing the APU 200 comprising configuring the APU 200 to provide one of an AC output and a DC output, as indicated by block 1105; and providing at least one ancillary component (not shown) for adapting the APU 200 with an electric drive motor 8 in relation to the vehicle 500′, as indicated by block 1106; performing one of installing, integrating, and retrofitting the APS 100 in relation to the vehicle, as indicated by block 1202; and operating the vehicle, as indicated by block 1203.

Still referring to FIG. 12, providing the APU 200, as indicated by block 1101, comprises configuring the APU 200 as retrofittable in relation to a vehicle 500, whereby the vehicle 500 is convertible to a series hybrid vehicle 500′, providing the compact turbine engine 10, as indicated by block 1102, comprises providing a JetCat® SPT15-RX gas-turbine turboprop engine with a gear reduction of approximately 14.1:1, providing the generator 20, as indicated by block 1103, comprises providing a custom Heinzmann® PMS-150 permanent-magnet synchronous generator, and providing the rectifier unit 30, as indicated by block 1104, comprises providing a custom full-wave rectifier and a rectifier circuit 31, the rectifier circuit 31 comprising a capacitance circuit. Providing the compact turbine engine 10, as indicated by block 1102, comprises configuring the compact turbine engine 10 to operate with at least one fuel of kerosene, diesel fuel, and biodiesel fuel.

Still referring to FIG. 12, providing the compact turbine engine 10, as indicated by block 1102, comprises configuring the compact turbine engine 10 to operate using a lubricant additive, such as a silicone-based lubricant additive, for enhancing certain operating conditions. The lubricant additive is used when running the compact turbine engine 10 on lighter hydrocarbon fuel, such as kerosene, JP-7, JP-8, and Jet-A1, wherein the ratio of the lubricant additive to the fuel is approximately 1:20. When running the compact turbine engine 10 on diesel, e.g., a “#2” diesel fuel, being a sufficiently heavy fuel, a lubricant additive is not required, but may be optionally used for long term durability, wherein the ratio of the lubricant additive to the fuel comprises a range of approximately 1:20 to approximately 1:80, and wherein the ratio of the lubricant additive to the fuel preferably comprises approximately 1:20, whereby the compact turbine engine 10 provides a nominal power output of approximately 15 kW. The compact turbine engine 10 has an optimal fuel consumption at approximately 75,000 RPM, and a maximum safe power output at approximately 132,000 RPM. The compact turbine engine 10 has a gearbox reduction of approximately 14.1:1 forward of the gas-turbine output shaft 11 and is capable of providing torque of approximately 32.7 N-m at its final drive ratio.

Referring back to FIGS. 1-12, the APS 100 may further comprise at least one of: a DC-to-AC converter (not shown), electrical inverters, and power conditioning elements. With regard to fuel consumption estimates for the vehicle 500′, such estimates are based on tests conducted with the APU 200 under load as well as the vehicle 500′ under varying driving conditions. As with any vehicle, providing an exact range under any condition is not possible, as fuel and power consumption will vary between different road conditions, traffic conditions, and even driver behavior. However, extensive testing has established that a battery pack 1, comprising a 25-kWh battery pack, in the vehicle 500′ has produced a range of at least approximately 65 km to approximately 145 km. The electric drive motor 8 has a power-draw in a range of approximately 20 A to approximately 60 A during regular operation, peaking at approximately 250 A for brief periods of time, such as during heavy-traffic driving, “sporty” driving, racing, and acceleration.

Still referring back to FIGS. 1-12, the APU 200 facilitates determining range estimates for at least that the compact turbine engine 10, e.g., a gas-turbine engine, consistently operates at a constant engine speed, whereby the turbine operational main shaft operates at an extremely high shaft speed, e.g., in a range of approximately 30,000 RPM (idle) to approximately 157,000 RPM (full throttle), whereby predictable fuel consumption data is gleanable having slight variations, e.g., in a range of approximately 80 ml/min to approximately 550 ml/min, depending on throttle setting, even under different load conditions, thereby eliminating many of the unpredictable and highly variable fuel consumption data relating to ICEs. Initial testing of the APS 100, comprising the APU 200, has resulted in an estimated fuel consumption rate range of approximately 340 km to approximately 615 kin, e.g., under freeway driving conditions and speeds. By example only, assuming a regular freeway speed of approximately 100 km/h, the fuel consumption is estimated in a range of approximately 21 km/l to approximately 3 km/l, depending on the turbine's throttle setting. For instance, operating the vehicle 500′ at approximately 80,000 RPM, e.g., having a fuel consumption in a range of approximately 185 ml/min to approximately 200 ml/min, resulting in a range of approximately 9 km/l to approximately 8.3 km/l.

Still referring back to FIGS. 1-12, by using the compact turbine engine 10, e.g., a more compact and lightweight gas-turbine engine, the APU 200 manages to achieve a higher power-to-weight ratio and better fuel economy than related art range-extending generator engines, such as those used in the Chevrolet® Volt®. The use of diesel fuel, or even biodiesel fuel, streamlines operation and distribution for both the consumer and the infrastructure, for at least that diesel fuel is readily available, that biodiesel fuel is readily prepared, and that reliance on the still-expanding charging grid is eliminated. Similarly, the charger component in the APS 100 is configured to utilize a 220-V level-2 charging via a J1772 connection port at an electric charging station as well as a typical 110-V outlet, thereby further streamlining usage and maintenance.

Still referring back to FIGS. 1-12, noted is that, while the electric charging grid is currently undergoing expansion in the State of California and has sufficient coverage in major population centers to support a large number of EVs, such circumstance is not the case in other parts of the United States of America or other countries in the world. However, diesel fuel and biodiesel fuel are readily available in many places in the world with limited or no access to the electrical grid. The APU 200 having the generator 20, e.g., a portable, compact, and lightweight power generation unit, is configured to provide both AC and DC currents; and, thus, the APU 200 has many implementations in geographic locations where at least some available electricity allows the vehicle 500′ to be much more consumer-friendly than a pure EV.

Still referring back to FIGS. 1-12, the APS 100 comprises the APU 200 having a unique configuration, wherein integration of the APS 100 into the vehicle 500′ improves the state of the hybrid vehicle industry. The APU 200 having a unique configuration, comprising the compact turbine engine 10, e.g., a gas-turbine engine, the generator 20, e.g., an electric generator, and being implemented in a vehicle 500, thereby converting the vehicle 500 into a hybrid vehicle 500′ is a viable and functional alternative to existing related art hybrid vehicles. The APU 200 is more powerful by weight relative to its related art approaches that are currently on the market, wherein the vehicle 500′ is capable of matching the performance of many current related art hybrid vehicles.

Still referring back to FIGS. 1-12, the vehicle 500′ exceeds the specifications and design parameters of both the vehicle 500, e.g., the base vehicle, and its turbo-charged counterpart. The performance values of the vehicle 500′ matches, or exceeds, many of the related art commercial passenger coupes and sedans. Further, retrofitting or upgrading a vehicle 500 into a vehicle 500′ comprises a streamlined installation process and is well-worth pursuing.

Having thus described the basic concept of the present disclosure, the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the present disclosure. Additionally, the recited order of processing elements or sequences, or the use of numbers, letters, or other designations therefore, is not intended to limit the claimed processes to any order except as may be specified in the claims. Accordingly, the present disclosure is limited only by the following claims and equivalents thereto.

At least some aspects, such as executable instructions, disclosed are embodied, at least in part, in software. Such software may provide instructions for operating any circuits of the present disclosure. That is, some disclosed techniques and methods are carried out in a computer system or other data processing system in response to its processor, such as a microprocessor, executing sequences of instructions contained in a memory, such as ROM, volatile RAM, non-volatile memory, cloud, cache, or a remote storage device.

A computer readable storage medium is used to store software and data which when executed by a data processing system causes the system to perform various methods or techniques of the present disclosure. The executable software and data is storable in various places, including for example ROM, volatile RAM, non-volatile memory, cloud, and/or cache. Portions of this software and/or data are stored in any one of these storage devices.

Examples of computer-readable storage media may include, but are not limited to, recordable and non-recordable type media such as volatile and non-volatile memory devices, read only memory (ROM), random access memory (RAM), flash memory devices, floppy and other removable disks, magnetic disk storage media, optical storage media, e.g., compact discs (CDs), digital versatile disks (DVDs), etc.), among others. The instructions can be embodied in digital and analog communication links for electrical, optical, acoustical or other forms of propagated signals, such as carrier waves, infrared signals, digital signals, and the like. The storage medium is the Internet cloud, or a computer readable storage medium such as a disc.

Furthermore, at least some of the methods described herein are capable of being distributed in a computer program product comprising a computer readable medium that bears computer usable instructions for execution by one or more processors, to perform aspects of the methods described. The medium is provided in various forms such as, but not limited to, one or more diskettes, compact disks, tapes, chips, universal server bus (USB) keys, external hard drives, wire-line transmissions, satellite transmissions, internet transmissions or downloads, magnetic and electronic storage media, digital and analog signals, and the like. The computer usable instructions may also be in various forms, including compiled and non-compiled code.

At least some of the elements of the systems described herein are implemented by software, or a combination of software and hardware. Elements of the system that are implemented via software are written in a high-level programming language such as object-oriented programming or a scripting language. Accordingly, the program code is written in C, C++, J++, hypertext, or any other suitable programming language and may comprise functions, modules or classes, as is known to those skilled in computer programming. At least some of the elements of the system that are implemented via software are written in assembly language, machine language or firmware as needed. In either case, the program code can be stored on storage media or on a computer readable medium that is readable by a general or special purpose programmable computing device having a processor, an operating system and the associated hardware and software that is necessary to implement the functionality of at least one of the embodiments described herein. The program code, when read by the computing device, configures the computing device to operate in a new, specific, and predefined manner for performing at least one of the methods described herein.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, any particular order to steps or stages of methods or processes described in this disclosure is not intended or implied. In many cases the order of process steps is varied without changing the purpose, effect, or import of the methods described.

Information as herein shown and described in detail is fully capable of attaining the above-described embodiments of the present disclosure and the presently preferred embodiment, if any, of the present disclosure, and is, thus, representative of the subject matter which is broadly contemplated by the present disclosure. The scope of the present disclosure fully encompasses other embodiments and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a device, an apparatus, a system, or a method to address each, and every, problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail is made, without departing from the spirit and scope of the present disclosure, as set forth in the appended claims, as is apparent, or may become apparent, to those of ordinary skill in the art, are also encompassed by the present disclosure.

### INDUSTRIAL APPLICABILITY

Generally, the present disclosure industrially applies to hybrid vehicle technologies. More particularly, the present disclosure industrially applies to power system technologies for hybrid vehicles. Even more particularly, the present disclosure industrially applies to series power system technologies for hybrid vehicles.

What is claimed:

1. An auxiliary power system for providing auxiliary power in relation to a vehicle, the system comprising:
an auxiliary power unit comprising a compact turbine engine, a generator coupled with the compact turbine engine, and a rectifier unit coupled with the generator, the auxiliary power unit configurable to provide one of an AC output and a DC output; and
at least one ancillary component for adapting the auxiliary power unit with an electric drive motor in relation to the vehicle.

2. The system of claim 1, wherein the auxiliary power unit is retrofittable in relation to a vehicle, whereby the vehicle is converted to a series hybrid vehicle.

3. The system of claim 1, wherein the compact turbine engine comprises a JetCat® SPT15-RX gas-turbine turboprop engine with a gear reduction of approximately 14.1:1.

4. The system of claim 1, wherein the generator comprises a custom Heinzmann® PMS-150 permanent-magnet synchronous generator.

5. The system of claim 1, wherein the rectifier unit comprises a custom full-wave rectifier and a rectifier circuit, the rectifier circuit comprising a capacitance circuit.

6. The system of claim 1, wherein the compact turbine engine is configured to operate with at least one fuel of kerosene, diesel fuel, and biodiesel fuel.

7. The system of claim 1,
wherein the compact turbine engine is configured to operate with a silicon-based lubricant additive at an additive-to-fuel mixture ratio in a range of approximately 1:20 to approximately 1:80, and
whereby the compact turbine engine provides a nominal power output of approximately 15 kW,
whereby the compact turbine engine has an optimal fuel consumption at approximately 75,000 RPM,
whereby the compact turbine engine has a maximum safe power output at approximately 132,000 RPM, and
whereby the auxiliary power unit provides torque of approximately 32.7 N-m at its final drive ratio.

8. The system of claim 1, further comprising at least one of: at least one DC-to-AC converter, at least one electrical inverter, and at least one power conditioner.

9. A method of fabricating an auxiliary power system for providing auxiliary power in relation to a vehicle, the method comprising:
providing an auxiliary power unit, providing the auxiliary power unit comprising providing a compact turbine engine, providing a generator coupled with the compact turbine engine, and providing a rectifier unit coupled with the generator, and providing the auxiliary power unit comprising configuring the auxiliary power unit to provide one of an AC output and a DC output; and
providing at least one ancillary component for adapting the auxiliary power unit with an electric drive motor in relation to the vehicle.

10. The method of claim 9, wherein providing the auxiliary power unit comprises configuring the auxiliary power unit as retrofittable in relation to a vehicle, whereby the vehicle is convertible to a series hybrid vehicle.

11. The method of claim 9, wherein providing the compact turbine engine comprises providing a JetCat® SPT15-RX gas-turbine turboprop engine with a gear reduction of approximately 14.1:1.

12. The method of claim 9, wherein providing the generator comprises providing a custom Heinzmann® PMS-150 permanent-magnet synchronous generator.

13. The method of claim 9, wherein providing the rectifier unit comprises providing a custom full-wave rectifier and a rectifier circuit, the rectifier circuit comprising a capacitance circuit.

14. The method of claim 9, wherein providing the compact turbine engine comprises configuring the compact turbine engine to operate with at least one fuel of kerosene, diesel fuel, and biodiesel fuel.

15. The method of claim 9,
wherein providing the compact turbine engine comprises configuring the compact turbine engine to operate with a silicon-based lubricant additive at an additive-to-fuel mixture ratio a range of approximately 1:20 to approximately 1:80, and
whereby the compact turbine engine provides a nominal power output of approximately 15 kW,
whereby the compact turbine engine has an optimal fuel consumption at approximately 75,000 RPM,
whereby the compact turbine engine has a maximum safe power output at approximately 132,000 RPM, and
whereby the auxiliary power unit provides torque of approximately 32.7 N-m at its final drive ratio.

16. The method of claim 9, further comprising providing at least one of: at least one DC-to-AC converter, at least one electrical inverter, and at least one power conditioner.

17. A method of providing auxiliary power in relation to a vehicle by way of an auxiliary power system, the method comprising:
providing the auxiliary power system, comprising:
providing an auxiliary power unit, providing the auxiliary power unit comprising providing a compact turbine engine, providing a generator coupled with the compact turbine engine, and providing a rectifier unit coupled with the generator, and providing the auxiliary power unit comprising configuring the auxiliary power unit to provide one of an AC output and a DC output; and
providing at least one ancillary component for adapting the auxiliary power unit with an electric drive motor in relation to the vehicle;
performing one of installing, integrating, and retrofitting the auxiliary power system in relation to the vehicle, thereby providing a hybrid vehicle; and
operating the hybrid vehicle.

18. The method of claim 17,
wherein providing the auxiliary power unit comprises configuring the auxiliary power unit as retrofittable in relation to a vehicle, whereby the vehicle is convertible to a series hybrid vehicle,
wherein providing the compact turbine engine comprises providing a JetCat® SPT15-RX gas-turbine turboprop engine with a gear reduction of approximately 14.1:1,
wherein providing the generator comprises providing a custom Heinzmann® PMS-150 permanent-magnet synchronous generator, and
wherein providing the rectifier unit comprises providing a custom full-wave rectifier and a rectifier circuit, the rectifier circuit comprising a capacitance circuit.

19. The method of claim 17, wherein providing the compact turbine engine comprises configuring the compact turbine engine to operate with at least one fuel of kerosene, diesel fuel, and biodiesel fuel.

20. The method of claim 17, further comprising providing at least one of: at least one DC-to-AC converter, at least one electrical inverter, and at least one power conditioner,
wherein providing the compact turbine engine comprises configuring the compact turbine engine to operate with a silicon-based lubricant additive at an additive-to-fuel mixture ratio a range of approximately 1:20 to approximately 1:80, and
whereby the compact turbine engine provides a nominal power output of approximately 15 kW,
whereby the compact turbine engine has an optimal fuel consumption at approximately 75,000 RPM,
whereby the compact turbine engine has a maximum safe power output at approximately 132,000 RPM, and
whereby the auxiliary power unit provides torque of approximately 32.7 N-m at its final drive ratio.
